(19) United States
(12) Patent Application Publication
(10) Pub. No.: US 2012/0060289 A1
(43) Pub. Date: Mar. 15, 2012

(54) SUPPORT DEVICE WHICH IS ADJUSTABLE BY AN ELECTRIC MOTOR

(75) Inventors: Eckhart DEWERT, Goldingen (CH); Jörg HENLE, Giebelstadt-Allersheim (DE)

(73) Assignee: Bionical Systems AG, Zurich (CH)

(21) Appl. No.: 13/275,086

(22) Filed: Oct. 17, 2011

Related U.S. Application Data
(63) Continuation of application No. PCT/EP2010/002063, filed on Mar. 31, 2010.

(30) Foreign Application Priority Data
Apr. 17, 2009 (DE) 10 2009 017 896.1

(51) Int. Cl. A61G 7/002; A47C 1/02; A47B 97/00

(52) U.S. Cl. 5/600; 248/372.1; 5/656

(57) ABSTRACT

Support device, which is adjustable by an electric motor, for cushioning of a piece of furniture for sitting and/or lying on has a base body, a first support section for supporting a person resting on support device, in a head/upper body region, and a second support section for supporting a person, in calf/thigh region. Stationary third support section is provided between the first and second support section. The first support section and/or the second support section have the three support parts which are pivotable in an articulated manner relative to one another and/or relative to the third support section. Electric motor drive is provided for adjusting the support parts. At least one separate actuating element is operatively associated with the individual support parts for pivoting a particular support part, and at least two support parts are pivotable independently.

### CROSS-REFERENCE TO RELATED APPLICATIONS

This application is a continuation of application no. PCT/EP2010/002063, filed Mar. 31, 2010, which claims the priority of German application no. 10 2009 017 896.1, filed Apr. 17, 2009, and each of which is incorporated herein by reference.

### FIELD OF THE INVENTION

The invention relates to a support device, which is adjustable by an electric motor, for cushioning of a piece of furniture for sitting and/or lying on.

### BACKGROUND OF THE INVENTION

Such support devices, for example in the form of slatted bed frames which are adjustable by an electric motor, are generally known, for example from EP 0 372 032 B1 and DE 199 62 541 C3.

A support device, which is adjustable by an electric motor, in the form of a slatted frame is known from DE 38 42 078 C2, having five support parts which are used for supporting a bed mattress. A head support part and an upper body support part which is connected in an articulated and pivotable manner to the head support part form a first support section for supporting a person, resting on the support device, in the head/upper body region. A second support section for supporting a person, resting on the support device, in the calf/thigh region is formed by a calf support part, and a thigh support part that is connected in an articulated and pivotable manner to the calf support part. A third support section is formed by a stationary center support part, one side of which is connected in an articulated manner to an upper body support part so as to be pivotable about a pivot axis, and the other side of which is connected in an articulated manner to the thigh support part so as to be pivotable about a pivot axis. With regard to the support parts, the known support device has a five-membered design. A similar support device is also known from DE 195 03 650 A1.

A deformable item of furniture for sitting or lying on is known from DE 39 12 442 A1, according to which changes in shape are possible at any point by means of bendable extruded profiles. FIGS. 8 and 9 show embodiments in which the extruded profiles are formed by link chains.

A slatted frame having a two-membered design is known from DE 693 26 756 T2 (corresponding to EP 0 632 985 B1), and is composed of a back part and a leg part, the leg part being formed by a plurality of parallel strips.

It is advantageous to design the support device with as many members as possible in order to achieve the greatest possible adaptation to the ergonomic and physiological circumstances. For this purpose, a support device, which is adjustable by an electric motor, of the type in question is known from DE 299 17 813 U1, having a multi-membered design. The support device known from the cited document has a base body which has a first support section for supporting a person, resting on the support device, in the head/upper body region, and a second support section for supporting a person, resting on the support device, in the calf/thigh region. A stationary third support section is situated between the first support section and the second support section, whereby the first support section, and in the support device known from the cited document, also the second support section, have at least three support parts which are pivotable in an articulated manner about a pivot axis, relative to one another and relative to the third support section. The known support device also has an electric motor drive for adjusting the support parts relative to one another. The electric motor drive is in operative connection, via a shared actuating element, with all of the support parts to be adjusted, whereby the actuating element may be formed by a traction band or pressure band.

### OBJECTS AND SUMMARY OF THE INVENTION

An object of the invention is to provide a support device, which is adjustable by an electric motor, for cushioning of a piece of furniture for sitting and/or lying on, and which is improved with regard to the available adjustment options and with regard to the adaptation to the ergonomic and/or physiological conditions.

This object is achieved by the invention set forth herein.

More particularly, the invention includes a support device, which is adjustable by an electric motor, for cushioning of a piece of furniture for one of sitting and lying on, and which includes:
a) a base body which has a first section, such as a first support section, for supporting a person, resting on the support device, in the head/upper body region, and a second support section for supporting a person, resting on the support device, in the calf/thigh region;
b) a stationary third support section being provided between the first support section and the second support section;
c) one of the first support section and the second support section having at least three support parts which are adjustable in an articulated manner about a pivot axis, relative to one another or relative to the third support section;
d) an electric motor drive being provided for adjusting the support parts relative to one another; and
e) at least one separate actuating element being associated with the respective individual support parts in order to pivot the particular support part, the actuating elements being in operative connection with the drive in such a way that at least two of the support parts are pivotable independently of one another.

According to the invention, in each case at least one separate actuating element is associated with the individual support parts in order to pivot the particular support part, the actuating elements being in operative connection with the drive in such a way that at least two support parts are pivotable independently of one another. Accordingly, the basic concept of the invention is to allow the individual support parts of a multi-membered support device, for example a slatted frame, to be actuated largely independently of one another with regard to their pivoting. In this manner, the shape of a support surface formed by the support parts of the support device may be better adapted to the ergonomic and physiological conditions of a user.

According to the invention, all support parts are actuatable independently of one another, for example in such a way that for a chain of consecutive support parts, the individual support parts pivot in succession. Thus, in such an embodiment the support parts are pivotable independently of one another. However, according to the invention it is also possible for some of the support parts to be pivotable independently of other support parts, while other support parts are pivotable only together with further support parts.

One advantageous further embodiment of the invention provides that the actuating elements each have a rod-like configuration. This results in a particularly simple and cost-effective configuration or construction. The actuating elements may be acted on by traction or pressure, depending on the particular requirements.

One extremely advantageous further embodiment of the invention provides that at least one support part at a distance from the guide of an actuating element guided on the support part has a contact surface, whereby in a first kinematic phase an active surface of the adjusting element or of an actuating element provided at an adjacent support part comes into contact with the actuating element and linearly displaces same, and in a second kinematic phase the active surface of the adjusting element or of the actuating element provided at the adjacent support part comes into contact with the contact surface of the support part, eccentrically with respect to its pivot axis, and pivots the support part about the pivot axis. In this embodiment, for example, a head support part and an upper body support part may be moved relative to a stationary support part by means of a particularly simple configuration. In the first kinematic phase the adjusting element, for example a slider of a spindle drive provided on the stationary support part, linearly displaces an actuating element which is guided on the upper body support part. The actuating element engages with the head support part, eccentrically with respect to the associated pivot axis, thus pivoting the head support part when the pusher is linearly displaced. As soon as the slider comes into contact with the contact surface of the upper body support part, the actuating element is not further linearly displaced, so that the head support part is not further pivoted. Instead, in the second kinematic phase the slider pushes against the upper body support part, eccentrically with respect to the associated rotational axis, so that the upper body support part, together with the already pivoted head support part, is pivoted. The corresponding kinematics of the support parts are thus achieved using only a few components.

Another extremely advantageous further embodiment of the invention provides that the adjusting element acts on at least one actuating element, and/or at least one actuating element acts on an adjacent actuating element, and/or at least one actuating element acts on the associated support part, with play. This embodiment is particularly advantageous when the force-transmitting components in the drive train of the support device are subjected to pressure during the pivoting of a support part or multiple support parts. However, if the force-transmitting components or at least one of these components is/are subjected to traction during the pivoting of a support part, the adjusting element may be fixedly connected to an actuating element, or an actuating element may be fixedly connected to an adjacent actuating element, or an actuating element may be fixedly connected to the associated support part.

Another advantageous further embodiment of the invention provides that at least one actuating element is subjected to pressure during the pivoting of the associated support part. This results in a particularly simple configuration, since in particular the actuating element is able to act on the associated support part with play.

According to another advantageous further embodiment, at least one actuating element is configured in the manner of a pusher.

The adjusting element may be provided in any desired suitable manner, preferably by the drive element of a linear drive. In this regard, one advantageous further embodiment of the invention provides that the adjusting element is a spindle nut, or is connected to a spindle nut, which is provided on a rotationally drivable threaded spindle so as to be movable in a non-twisting manner in the axial direction. Such spindle drives are available as simple, inexpensive, and robust standard components, and are suitable for transmitting large forces.

One advantageous further embodiment, in particular the embodiment in which at least one actuating element is subjected to pressure during the pivoting of the associated support part, provides that the adjusting element is designed as a slider. In combination with the previously described embodiment, the slider may be formed by the spindle nut or connected to the spindle nut.

According to another advantageous further embodiment, the actuating elements cooperate with the drive in such a way that the support parts pivot in succession.

Another extremely advantageous further embodiment of the invention provides that the lengths of the actuating elements, and in each case the distance of the active surface of an actuating element from the contact surface of the associated support part in an unadjusted position of the support parts, are dimensioned in such a way that the support parts pivot in succession. In this manner a particularly ergonomic adjustment is achievable in which, for example, first a head support part is pivoted, and subsequently an upper body support part of a slatted frame is pivoted. The number of support parts is selectable within a wide range in all embodiments of a support device according to the invention.

According to another advantageous further embodiment of the invention, the actuating elements cooperate with the drive in such a way that at least two support parts pivot simultaneously or essentially simultaneously.

Another further embodiment of the invention provides that the lengths of the actuating elements, and in each case the distance of the active surface of an actuating element from the contact surface of the associated support part in the unadjusted position of the support parts, are dimensioned in such a way that the support parts pivot simultaneously or essentially simultaneously.

In the sense of a simple and cost-effective configuration, using the smallest possible number of different components, another advantageous further embodiment provides that the actuating elements are essentially the same length.

Another further embodiment of the invention provides that in an unadjusted position, the distance of the active surface of an actuating element from the contact surface of the associated support part decreases from the actuating element closest to the adjusting element to the actuating element farthest from the adjusting element. When the actuating elements have essentially the same length, in this embodiment kinematics result in which the support part which is farthest from the adjusting element, and thus from the drive, pivots first, and subsequently the support parts closer to the drive pivot in succession.

Another advantageous further embodiment of the invention provides that the support device is configured as a slatted frame in which the support parts have elastic slats for supporting a bed mattress.

Another further embodiment of the invention provides that the support device is designed as a recliner, in particular an outdoor lounge recliner.

The number of support parts is selectable within a wide range, depending on the particular requirements. Depending on the particular requirements, for example, a support device having a single adjustable support part or also a support device having a plurality of mutually adjustable support parts may be implemented.

The invention is explained in greater detail below with reference to the accompanying drawings, which illustrate embodiments of a support device according to the invention. All features that are described, illustrated in the drawings, and set forth in the claims constitute the subject matter of the invention, taken alone or in any given combination, independently of their combination in the claims and their dependencies, and independently of their description or illustration in the drawings.

Relative terms such as left, right, up, down are for convenience only and are not intended to be limiting.

### BRIEF DESCRIPTION OF THE DRAWINGS

FIG. 1 shows, in a partially sectional side view, an embodiment of a support device according to the invention in the form of a slatted frame, in a first adjustment position;

FIGS. 2A-2C show a schematic diagram for illustrating the basic principle of the invention;

FIG. 3 shows a perspective view of the support device corresponding to the embodiment of FIG. 1; and

FIGS. 4A-4F show, in the same representation as in FIG. 1, the support device corresponding to the embodiment of FIG. 1 in various adjustment positions.

### DETAILED DESCRIPTION OF THE INVENTION

The embodiment of the support device 2 according to the invention illustrated in the figures is designed as a slatted frame; for the sake of clarity, in each case only the base body of the slatted frame, without slats, is illustrated.

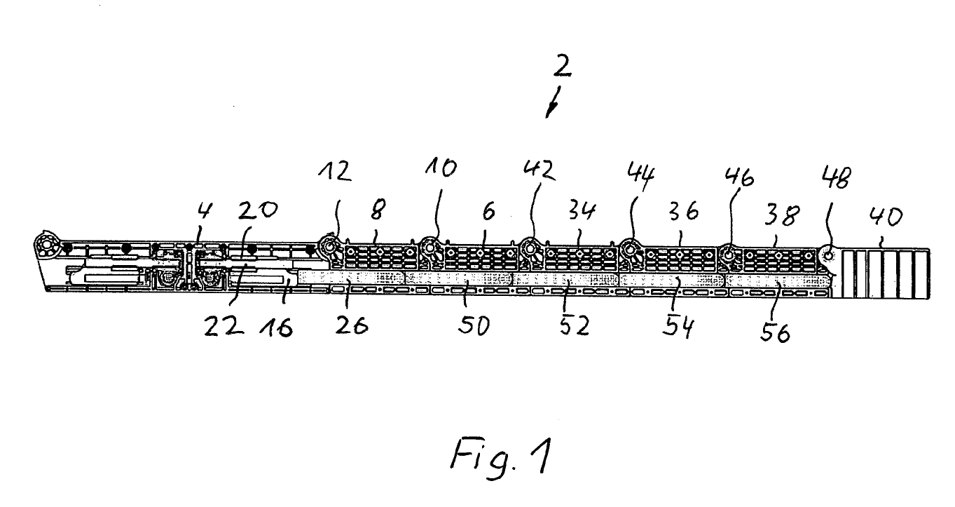

FIG. 1 illustrates in a partially sectional side view one embodiment of a support device 2 according to the invention in the form of a slatted frame, having a first support part 4 which in the present embodiment is formed by a stationary support part. The support device 4 also has a second support part 6. In the longitudinal direction of the support device 2, a third support part 8 is provided between the first support part 4 and the second support part 6. FIG. 1 illustrates only a portion of the support device 2 which is provided for supporting the upper body support part and head support part 8 and 6, respectively. A portion of the support device 2 which is provided for supporting the calf and thigh region has a similar configuration, and therefore is not explained in further detail.

The second support part 6 is connected in an articulated manner to the third support part 8 so as to be pivotable about a horizontal pivot axis 10, which in FIG. 1 extends into the plane of the drawing, and which is connected to the first support part 4 in an articulated manner so as to be pivotable about a horizontal pivot axis 12, which in FIG. 1 extends into the plane of the drawing. An electric motor drive 14, which is explained in greater detail below, is provided for pivoting the second support part 6 and the third support part 8 relative to one another and relative to the first support part 4.

The electric motor drive 14 has an adjusting element, which in the present embodiment is designed as a slider 16 which is movable back and forth in the direction of a double arrow 18. In the present embodiment, the slider 16 is connected in a nondisplaceable manner to a spindle nut 20 so as to be movable in the axial direction in a non-twisting manner on a threaded spindle 22 which is in rotary drive connection with an electric motor, not visible in FIG. 1, via a worm gear 24. The spindle nut 20 and therefore the slider 16 moves to the right or to the left in FIG. 1, corresponding to the rotational direction of the output shaft of the electric motor, and thus of the threaded spindle 22.

The slider 16 is connected in a force-transmitting manner to the second support part 6 via an actuating element 26 for pivoting the second support part. In the present embodiment, the actuating element 26 has a rod-like design, and by means of the slider 16 is guided in a linearly displaceable manner in a guide which is formed in the third support part 8. In the illustrated embodiment, the slider 16 acts on the end of the rod-like actuating element facing away from the second support part 6, with play, in the present embodiment the actuating element being designed in the manner of a pusher. To avoid lateral buckling of the actuating element 26 when acted on by pressure during pivoting of the second support part 6, either the actuating element 26 is narrowly led in the guide along its entire length, or guide elements are provided at short intervals in the longitudinal direction of the actuating element 26, the spacing between the guide elements being selected to be small enough that buckling of the actuating element 26 is avoided. The guide elements may have a web- or rib-like design, for example.

As is apparent from FIG. 1, the rod-like actuating element 26 engages with the second support part 6, eccentrically with respect to the pivot axis 10, in order to pivot the second support part 6.

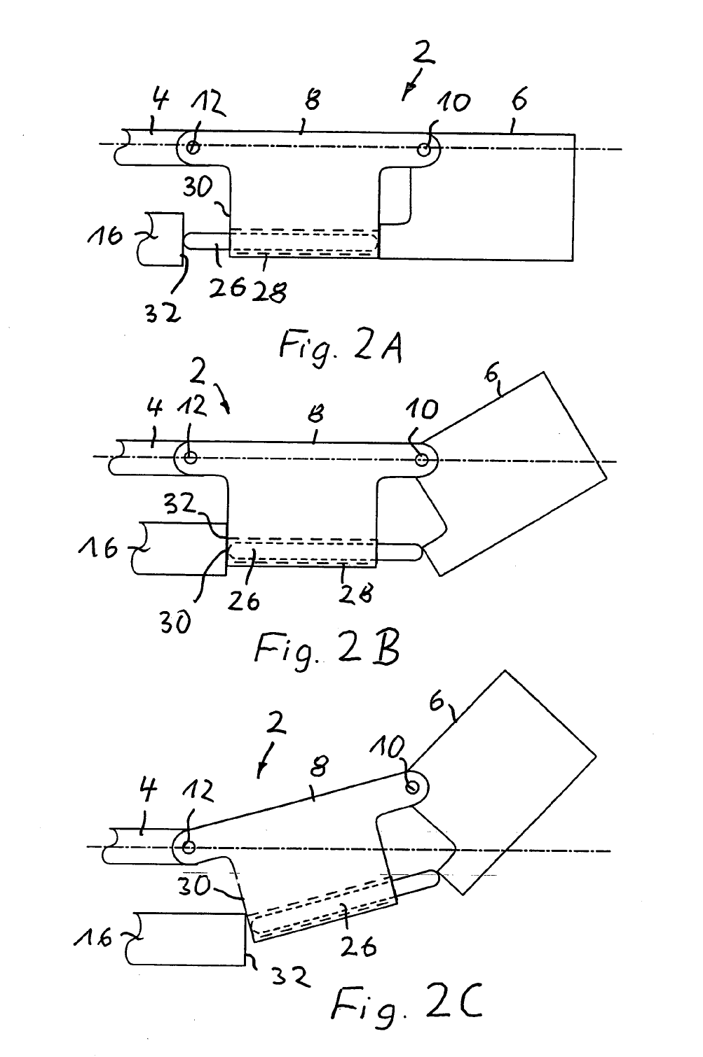

The underlying adjustment principle is explained in greater detail below with reference to FIGS. 2A through 2C. FIGS. 2A through 2C are used solely for explaining the underlying adjustment principle; thus, the support parts 4, 6, 8 are shown in highly schematic form and are not illustrated to scale.

FIG. 2A shows the support parts 4, 6, 8 in an adjustment position in which the support parts 4, 6, 8 together span an essentially horizontal support plane. This adjustment position corresponds to an unadjusted position of the support device 2.

As illustrated in FIG. 2A, at the third support part 8 the actuating element 26 is led in a guide 28 which is formed by a continuous channel-like recess, and is displaceably guided in its longitudinal direction at the third support part 8. At a distance from the guide 28, in the present embodiment the third support part 8 has a contact surface 30 at its end face which faces the slider 16, with which an active or working surface 32 of the slider 16 which faces the third support part 8 cooperates in a manner explained in greater detail below with reference to FIGS. 2B and 2C.

In a first kinematic phase, the slider 16 pushes against the actuating element 26, so that the actuating element is moved to the right in FIG. 2A. Since the end of the actuating element 28 facing away from the slider 32 engages with the second support part 6 eccentrically with respect to the pivot axis 10, the second support part 6 is pivoted in the counterclockwise direction.

FIG. 2B illustrates the end of the first kinematic phase, in which the second support part 6 is pivoted to the maximum extent in the counterclockwise direction relative to the third support part 8.

In a second kinematic phase, the active surface 32 of the slider 16 comes into contact with the contact surface 30 of the third support part 8. In the illustrated embodiment, for this purpose the cross section of the slider 16 at its free end, i.e., in the region of the active surface 32, is larger than the inner diameter of the guide 28, at least in one dimension. As a result of this design, in the second kinematic phase the actuating element 26 is not displaced further relative to the third support part 8. Instead, in the second kinematic phase the slider 16 pushes against the third support part 8, eccentrically with respect to the pivot axis 12, causing the third support part to pivot in the counterclockwise direction, as illustrated in FIG. 2C.

In this manner, with the aid of the actuating element the second support part 6 is pivoted, namely, in the first kinematic phase, and the third support part 8 is pivoted, namely, in the second kinematic phase.

As is apparent from FIGS. 2A through 2C, the slider 16 acts on the actuating element 26, and the actuating element 26 acts on the second support part 6, with play.

The support parts 6, 8 are returned to the starting position illustrated in FIG. 2A, corresponding to an unadjusted position of the support device 2, under the weight force of the support parts 6, 8, but with the drive switched on, whereby the spindle nut 20 and the slider 16 move to the left in FIG. 1.

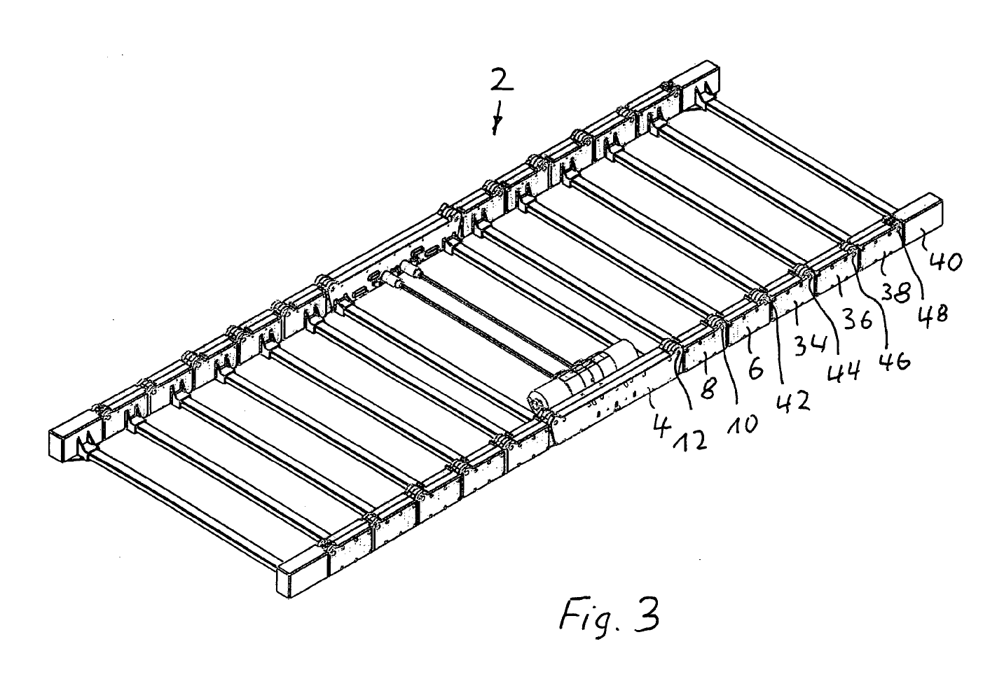

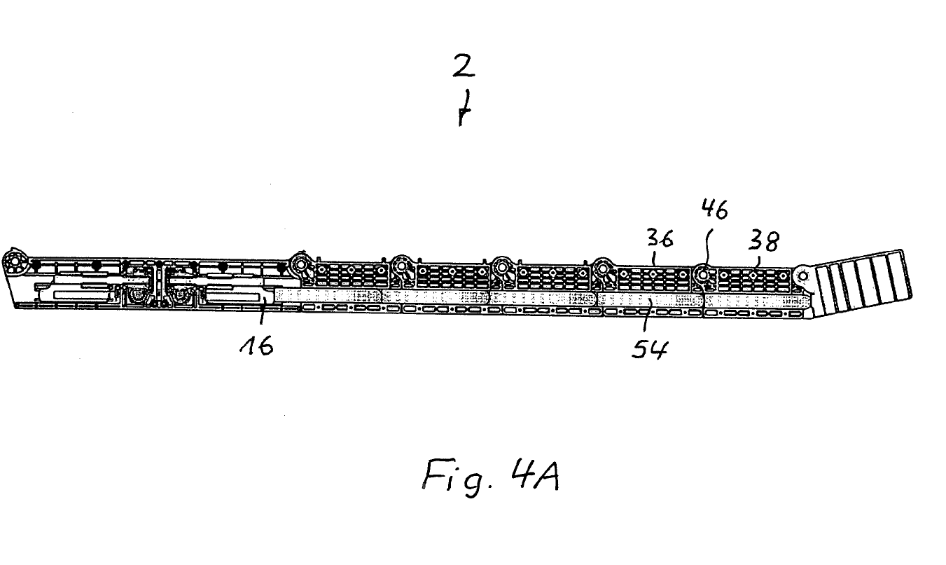

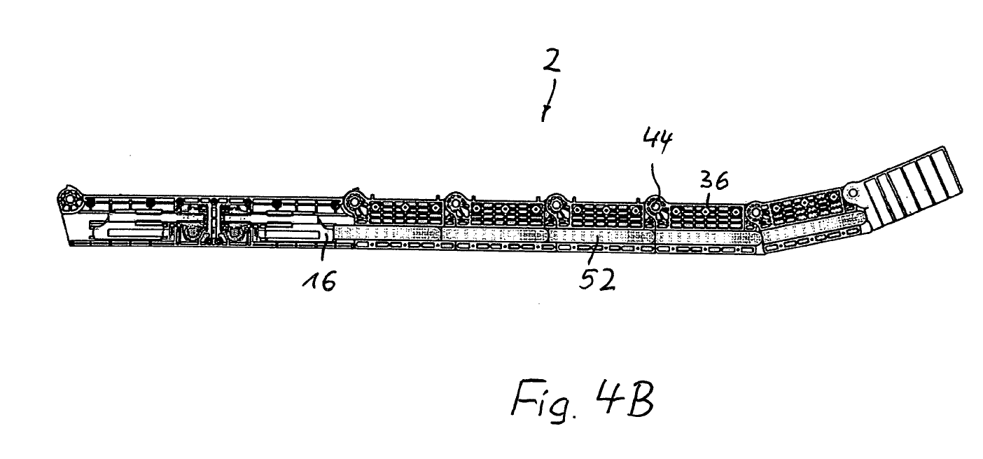

FIG. 3 shows the support device 2 according to FIG. 1 in a perspective view, it being apparent that a fourth support part 34, a fifth support part 36, a sixth support part 38, and a seventh support part 40 are provided in addition to the first support part 4, the second support part 6, and the third support part 8. In each case, adjacent support parts 4-8 and 34-40 are connected to one another in an articulated manner so as to be pivotable about a horizontal pivot axis 12, 10, 42, 44, 46, or 48, respectively. In the illustrated embodiment, the support parts 8, 6, and 34-40 form a first support section for supporting a person, resting on the support device 2, in the upper body/head region, while the stationary first support part 4 forms a third support section. Support parts (not denoted in greater detail in FIG. 3) which are connected to the side of the first support part 4 facing away from the third support part 8 form a third support section for supporting a person, resting on the support device 2, in the calf/thigh region.

It is apparent from FIG. 1 that a further actuating element 50, 52, 54, or 56, each designed in the manner of a pusher, is associated with the respective further support part 34, 36, 38, or 40. In the illustrated embodiment, with regard to their structure and the cooperation with the associated actuating element the support parts 6, 34, 36, 38 have a configuration as described above with reference to the third support part 8. Similarly, the actuating elements 50, 52, 54, 56 have a configuration as described above with reference to the actuating element 26.

As is also apparent from FIG. 1, in the adjustment position illustrated in FIG. 1, in which the support parts 8, 6, 34, 36, 38, 40 span an essentially horizontal support plane and correspond to an unadjusted position of the support device 2, the end faces of the actuating elements 26, 50, 52, 54, 56 contact one another and the slider 16 and the support part 40, with play.

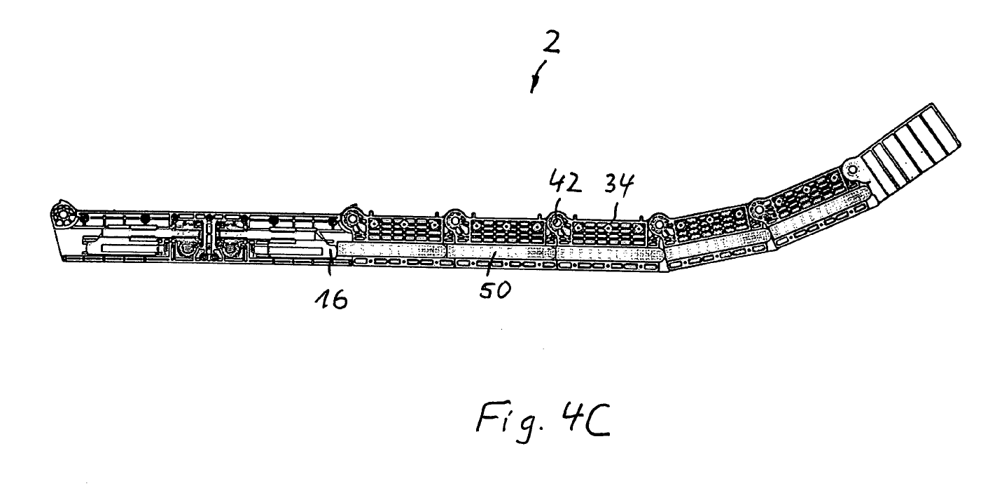

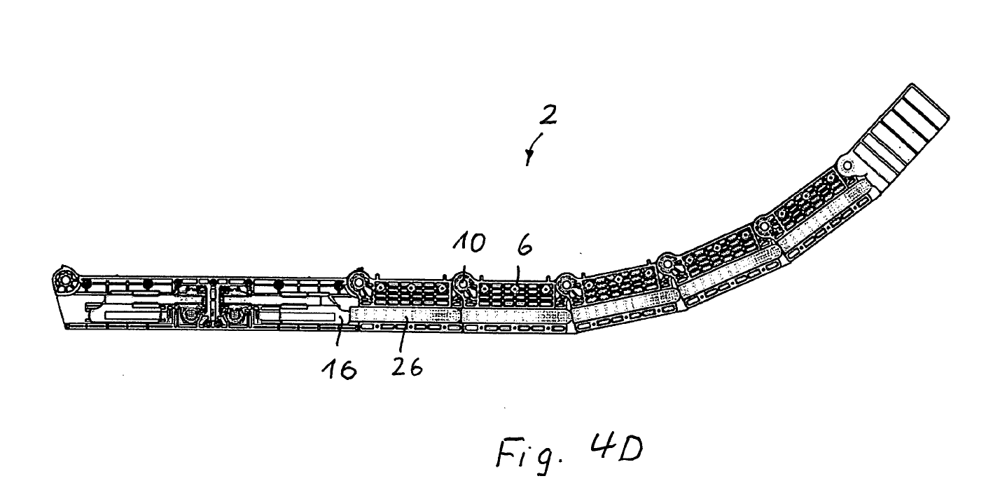

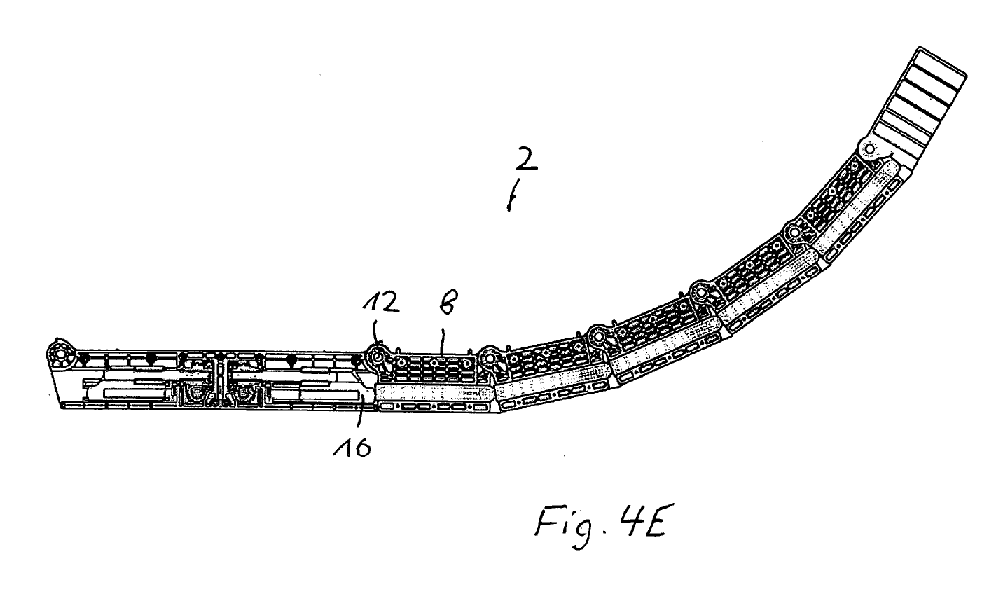

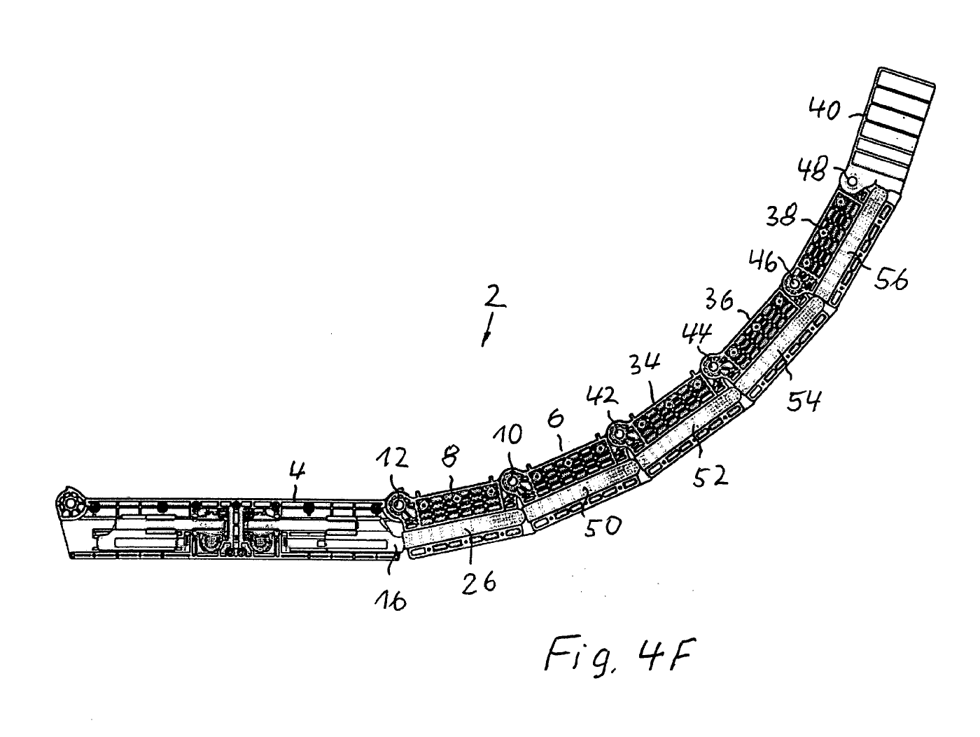

FIGS. 4A through 4F illustrate various kinematic phases during the adjustment of the support device 2. For the sake of clarity, essentially only the reference numerals of the components being referenced are provided in FIG. 4A through 4F. To adjust the support parts of the support device 2, the threaded spindle 22 is rotationally driven in such a way that the spindle nut 20, and thus the slider 16, moves to the right in FIG. 1. The slider 16 moves the actuating element 26 to the right in FIG. 1, so that the latter likewise moves the actuating elements 50, 52, 54 and 56 to the right in FIG. 1. Initially, the active surface of the actuating elements 26, 50, 52, 54 and of the slider 16 in each case is still at a distance from the contact surface of the associated support part 8, 6, 34, 36, 38 (see FIG. 2A), so that the support parts 8, 6, 34, 36, 38 initially remain unpivoted with respect to one another, while the support part 40 is pivoted in the counterclockwise direction in the figure until reaching the pivot position illustrated in FIG. 4A.

In the position of the actuating elements illustrated in FIG. 4A, the active surface of the actuating element 54 comes into contact with the contact surface of the associated sixth support part 38, eccentrically with respect to the pivot axis 46, so that the sixth support part 38 is pivoted in the counterclockwise direction in FIG. 4A about the pivot axis 46 relative to the fifth support part 36. The active surfaces of the slider 16 and of the actuating elements 26, 50, 52 are initially still at a distance from the contact surfaces of the associated support parts, so that the support parts 8, 6, 34, 36 are not pivoted initially.

FIG. 4B illustrates an adjustment position in which the active surface of the actuating element 52 comes into contact with the contact surface of the fifth support part 36, eccentrically with respect to the pivot axis 44, so that the fifth support part 36 is pivoted in the counterclockwise direction in FIG. 4B upon further movement of the slider to the right in FIG. 4B.

Upon further movement of the slider 16 to the right in FIG. 4B, the active surface of the actuating element 50 comes into contact with the contact surface of the associated fourth support part 34, eccentrically with respect to the pivot axis 42, so that the fourth support part 34 is pivoted in the counterclockwise direction in FIG. 4C about the pivot axis 42.

Upon further movement of the slider 16 in FIG. 4C, in the position illustrated in FIG. 4D the active surface of the actuating element 26 comes into contact with the contact surface of the associated second support part 6, eccentrically with respect to the pivot axis 10, so that the second support part 6 is pivoted in the counterclockwise direction in FIG. 4D relative to the third support part 8.

Upon further movement of the slider 16 to the right in FIG. 4D, in the position illustrated in FIG. 4E the active surface of the slider 16 comes into contact with the contact surface of the associated third support part 8, eccentrically with respect to the pivot axis 12, so that the third support part 8 is pivoted in the counterclockwise direction in FIG. 4E relative to the first support part 4.

FIG. 4F illustrates the end position of the adjustment motion, which corresponds to a maximum adjusted position of the support parts of the support device 2.

It is apparent from the preceding description of FIGS. 1 and 4A through 4F that the support parts 40, 38, 36, 34, 6, 8 are pivoted in succession, starting with support part 40. An actuating element, for example actuating element 54, initially linearly moves the adjacent actuating element, for example actuating element 56, until the active surface of the actuating element comes into contact with the contact surface of the associated support part, for example the sixth support part 38. Upon further movement of the actuating element 54, the sixth support part 38 is then pivoted. This also applies in the described manner for the further actuating elements 56, 52, 50, 26, and the slider 16.

As is apparent from FIG. 1, in the illustrated embodiment the actuating elements 26, 50, 52, 54, 56 have essentially the same length. As is further apparent from FIG. 1, in the unadjusted position of the support device 2 the distance of the active surface of an actuating element from the contact surface of the associated support part, for example the distance of the active surface of the actuating element 56 from the contact surface of the associated support part 40, decreases from the actuating element which is closest to the slider 16, i.e., actuating element 26, to the actuating element which is farthest from the slider 16, namely, actuating element 56. The desired kinematics in each case are adjustable by an appropriate selection of the lengths of the actuating elements.

In a modification of the embodiment according to FIG. 1 it is possible, for example, to simultaneously increase the length of the actuating element 52 and decrease the length of the actuating element 54 in such a way that the active surface of the actuating element 54 comes into contact with the contact surface of the sixth support part 38 at the same time that the active surface of the actuating element 52 comes into contact with the contact surface of the associated fifth support part 36. In this case, the seventh support part 40 is pivoted relative to the sixth support part 38, while the support parts 36, 38 are not pivoted relative to one another. In this manner the kinematics of the support parts may be adapted to the particular requirements.

As the result of a separate actuating element in each case being associated according to the invention with support parts 4 through 8 and 34 through 40, according to the invention at least two support parts, in the illustrated embodiment all support parts, are pivotable independently of one another. In this manner the shape of the support surface formed by the support parts is adaptable to the ergonomic conditions within a wide range.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. Support device, which is adjustable by an electric motor, for cushioning of a piece of furniture for one of sitting and lying on, comprising:
a) a base body having a first support section for supporting a person, resting on the support device, in the head/upper body region, and a second support section for supporting a person, resting on the support device, in the calf/thigh region;
b) a stationary third support section being provided between the first support section and the second support section;
c) one of the first support section and the second support section having at least three support parts which are adjustable in an articulated manner about a pivot axis, relative to one another or relative to the third support section;
d) an electric motor drive being provided for adjusting the support parts relative to one another; and
e) at least one separate actuating element being operatively associated with the respective individual support parts in order to pivot the particular support part, the actuating elements being in operative connection with the drive in such a way that at least two of the support parts are pivotable independently of one another.

2. Support device according to claim 1, wherein:
a) the respective actuating elements have a rod-shaped configuration.

3. Support device according to claim 2, wherein:
a) at least one support part at a distance from the guide of an actuating element guided on the support part has a contact surface, whereby in a first kinematic phase an active surface of the adjusting element or of the actuating element provided at an adjacent support part comes into contact with the actuating element and linearly displaces same, and in a second kinematic phase the active surface of the adjusting element or of the actuating element provided at an adjacent support part comes into contact with the contact surface of the support part, eccentrically with respect to its pivot axis, and pivots the support part about the pivot axis.

4. Support device according to claim 1, wherein:
a) at least one support part at a distance from the guide of an actuating element guided on the support part has a contact surface, whereby in a first kinematic phase an active surface of the adjusting element or of the actuating element provided at an adjacent support part comes into contact with the actuating element and linearly displaces same, and in a second kinematic phase the active surface of the adjusting element or of the actuating element provided at an adjacent support part comes into contact with the contact surface of the support part, eccentrically with respect to its pivot axis, and pivots the support part about the pivot axis.

5. Support device according claim 4, wherein:
a) the adjusting element acts on at least one actuating element, or at least one actuating element acts on an adjacent actuating element, or at least one actuating element acts on the associated support part, with play.

6. Support device according to claim 1, wherein:
a) the at least one actuating element is subjected to pressure during the pivoting of the associated support part.

7. Support device according to claim 1, wherein:
a) at least one actuating element is configured as a pusher.

8. Support device according to claim 4, wherein:
a) the adjusting element is a spindle nut or is connected to a spindle nut, which is provided on a rotationally drivable threaded spindle so as to be movable in a non-twisting manner in the axial direction.

9. Support device according to claim 4, wherein:
a) the adjusting element includes a slider.

10. Support device according to claim 1, wherein:
a) the actuating elements cooperate with the drive in such a way that at least two of the support parts pivot in succession.

11. Support device according to claim 1, wherein:
a) the lengths of the actuating elements, and in each case the distance of an active surface of an actuating element from a contact surface of the associated support part in the unadjusted position of the support parts, are dimensioned in such a way that the support parts pivot in succession.

12. Support device according to claim 1, wherein:
a) the actuating elements cooperate with the drive in such a way that at least two of the support parts pivot simultaneously or essentially simultaneously.

13. Support device according to claim 2, wherein:
a) the lengths of the actuating elements, and in each case the distance of the active surface of an actuating element from the contact surface of the associated support part in the unadjusted position of the support parts, are dimensioned in such a way that the support parts pivot simultaneously or essentially simultaneously.

14. Support device according to one claim 1, wherein:
a) the actuating elements are essentially the same length.

15. Support device according to claim 4, wherein:
a) the distance of an active surface of an actuating element from a contact surface of the associated support part decreases from the actuating element closest to the adjusting element to the actuating element farthest from the adjusting element.

16. Support device according to claim 1, wherein:
a) the support device is configured as a slatted frame in which the support parts have elastic slats for supporting a bed mattress.

17. Support device according to claim 1, wherein:
a) the support device is configured as a recliner, in particular an outdoor lounge recliner.
